(19) United States
(12) Patent Application Publication
(10) Pub. No.: US 2025/0315611 A1
(43) Pub. Date: Oct. 9, 2025

(54) AUTOMATED VALIDATION AND DEPLOYMENT OF MACHINE LEARNING MODELS AS A SERVICE

(71) Applicant: RAYMOND JAMES FINANCIAL, INC., Saint Petersburg, FL (US)

(72) Inventors: Jeff Griffith, Saint Petersburg, FL (US); Sujeet Pillai, Saint Petersburg, FL (US); Satish Anjilvel, Saint Petersburg, FL (US); Vicky Chandwani, Saint Petersburg, FL (US); Sourabh Ghosh, Saint Petersburg, FL (US)

(21) Appl. No.: 18/630,706

(22) Filed: Apr. 9, 2024

(51) Int. Cl. G06F 40/20; G06F 16/383

(52) U.S. Cl. CPC G06F 40/20; G06F 16/383

(57) ABSTRACT

Systems, methods, and computer-readable media are disclosed for systems and methods for automated validation and deployment of machine learning models as a service. Example methods may include determining a first request for generation of a first machine learning model, automatically generating the first machine learning model using the first set of features, automatically validating the first machine learning model, deploying the first machine learning model in a production network environment, and updating the first machine learning model using the first set of feedback signals. Methods may include determining a second request for an artificial intelligence output via the graphical user interface, determining a data input associated with the second request, selecting, based on the data input, a first large language model from a set of large language models, generating the artificial intelligence output using the first large language model, and causing presentation of the artificial intelligence output.

### BACKGROUND

Machine learning models are effective tools for performing tasks accurately and efficiently when provided with input data sets. However, it may be difficult for a user that is not a data scientist to determine which particular type of machine learning model is best suited to perform desired tasks. Even if such users are able to identify a particular model, the users may not have the requisite knowledge to train the model, interpret metrics associated with the performance of the model to determine how to optimize performance of the model, etc. Accordingly, automated validation and deployment of machine learning models as a service may be desired.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic illustration of an example use case for automated validation and deployment of machine learning models as a service in accordance with one or more example embodiments of the disclosure.

FIG. 2 is a schematic illustration of example system architecture for automated validation and deployment of machine learning models in accordance with one or more example embodiments of the disclosure.

FIG. 3 is a schematic illustration of an example process flow for automated validation and deployment of machine learning models as a service in accordance with one or more example embodiments of the disclosure.

FIG. 4 is an example flow diagram for automated validation and deployment of machine learning models and an example data architecture in accordance with one or more example embodiments of the disclosure.

FIGS. 5-6 are example user interfaces for automated validation and deployment of machine learning models in accordance with one or more example embodiments of the disclosure.

FIG. 7 is a schematic block diagram of an illustrative device in accordance with one or more example embodiments of the disclosure.

### DETAILED DESCRIPTION

### Overview

This disclosure relates to, among other things, devices, systems, methods, computer-readable media, techniques, and methodologies for automated validation and deployment of machine learning models as a service. Machine learning models are effective mechanisms by which tasks may be performed in an efficient and automated manner. However, there are many different types of machine learning models, and each type of model is more suited than other types of models to perform particular types of tasks. Non-limiting examples of different types of tasks may include structures data extraction, communication drafting, text review and editor assistance, text classification, text inference, text summarization, synthetic data generation, code generation, code re-write, code documentation, test generation, form filler, general tasks, custom prompts, etc. While reference is made generally to machine learning herein, any other types of artificial intelligence may also be used.

Structured data extraction involves transforming semi-structured or free-form text into clearly defined structured data. Communication drafting involves assisting in crafting various forms of communication, from emails to detailed reports. Text review and editor assistance involves reviewing and suggesting improvements for written communication to ensure clarity and professionalism. Text classification involves classifying a given data. Text inference involves distilling complex, lengthy texts into simplified, digestible insights. Text summarization involves condensing extensive financial documents or reports into succinct, accessible summaries. Synthetic Data generation involves producing synthetic data for various testing scenarios, facilitating more robust software testing. Code generation involves generating code from a list of functional/non-functional requirements. Code re-write involves optimizing or re-writing a given piece of code, translating between programming languages if required. Code documentation involves automatically generating meaningful documentation for a provided section of code. Test generation involves automatically creating test cases for a provided section of code. Form filler involves populating a form given a text input. General tasks may involve performing a task or a sequential flow of tasks to generate the output from a given input. Custom prompts involve performing any task that can be described as a custom prompt with details on what the inputs will be and what the expected output is. This list of different types of tasks that may be performed by machine learning models is merely intended to illustrate the wide variety of tasks that may be performed by machine learning models and any other tasks may similarly be performed as well.

The system described herein provides a collaborative platform that determines the specific type of machine learning model that is best suited to perform a task or tasks associated with a use case provided by a user. Accordingly, the collaborative platform is configured to receive requests for processing of different use cases involving different types of data and desired output formats, determine the most effective machine learning models to use for the different use cases, train the models, and deploy the models in a live environment to perform the tasks either in an automated fashion or upon subsequent request by the user. For example, a first user may desire for the collaborative platform to identify and train a machine learning model that can identify features of real-estate properties that most contribute to sale price within a given region. A second user may desire for the collaborative platform to identify and train a machine learning model that can predict weather patterns. A third user may desire for the collaborative platform to identify and train a machine learning model to analyze data obtain from a vehicle diagnostics device to determine the root cause of an issue with a vehicle.

Users may access the collaborative platform, provide information about use cases for which the users desire to leverage machine learning models, and the collaborative platform may automatically progress through a series of phases to test various candidate machine learning models to identify a specific machine learning model that should be deployed to perform tasks associated with the use case. The collaborative platform may also iteratively train the selected machine learning model to optimize the performance of the model to perform the tasks. Once the model is identified and optimized, the model may be deployed in a live environment to perform the tasks associated with the use case for the user.

In this manner, the collaborative platform may maintain a number of machine learning models that may be specifically trained to perform any number of different tasks for any number of different users. The collaborative platform may also allow a single user to maintain a listing of multiple use cases associated with different tasks the user desires to be performed using machine learning models generated by the collaborative platform. That is, the collaborative platform provides a centralized system that may be accessed by a user to leverage different machine learning models to perform a variety of tasks. The collaborative platform may be accessed via an application such that the user may provide indications of use cases, provide data, view a listing of saved use cases, view results produced by trained machine learning models generated to perform the saved use cases for the user, and/or any other functionality associated with the generation and subsequent usage of machine learning models to perform tasks.

In addition to automatically identifying a specific machine learning models to perform tasks associated with a use case, training the models, and deploying the model for use in a live environment, the collaborative platform may also provide a knowledge management and question-answering service that allows users to create custom knowledge bases and interact with them using language models. At its core, this service leverages the retrieval-augmented generation (RAG) architecture, combining the generative capabilities of large language models (LLMs), or other types of natural language processing models, with the ability to retrieve and reason over external data.

The service provides a flexible and user-friendly experience by offering both a web-based user interface (UI) and programmatic application programming interfaces (APIs). Through either the UI or APIs, users can create and manage their own knowledge bases, which may be vector databases, for example. Users can associate custom metadata with their knowledge bases, such as specific categories, access levels, or any other relevant attributes. When ingesting documents into the knowledge base, users can provide values for this custom metadata. This metadata can be used for various purposes, such as enforcing entitlements or access control, ensuring that users can only access and interact with documents for which they have the appropriate permissions. The service may then encode and store these documents, along with their associated metadata, as dense vector representations, enabling efficient semantic search and retrieval.

Once a knowledge base is populated, the core functionality of searching and interacting with the knowledge can be accessed through either the UI or APIs. The search capability allows users to enter natural language queries, which are then mapped to the semantic vector space. The service retrieves the most relevant documents from the knowledge base based on vector similarity and respects the metadata-based filtering, ensuring that users only receive responses from the relevant documents.

The language model, augmented with the retrieved context, generates natural language responses, effectively allowing users to “chat” with their knowledge base through both the UI and APIs. This powerful combination of retrieval and generation enables users to ask follow-up questions, seek clarifications, or dive deeper into specific topics, all while being grounded in the factual information contained within their accessible subset of the knowledge base.

The collaborative platform may also include a comprehensive evaluation framework to assess and enhance the performance of the machine learning models used for the machine learning models as a service. This framework may encompass two distinct components: the RAG evaluation framework and the machine learning model evaluation framework.

The RAG evaluation framework is specifically designed to quantify the effectiveness of the knowledge management and question-answering service. By experimenting with different components of the RAG architecture, such as retrieval methods, embedding models, and generation models, the RAG evaluation framework may identify areas for improvement and optimize the system's performance. This framework also provides valuable insights into the strengths and weaknesses of the knowledge management and question-answering service, enabling the system to automatically refine and enhance its capabilities to better meet the diverse needs of end-users.

The machine learning model evaluation framework is dedicated to quantifying the performance of different machine learning models across various machine learning models as a service use cases. By systematically evaluating and benchmarking machine learning models on a range of tasks and scenarios, the most suitable models may be identified for specific use cases, ensuring optimal performance and efficiency. The machine learning model evaluation framework incorporates a comprehensive set of metrics and evaluation protocols, allowing the system to make informed decisions when selecting and deploying machine learning models for different purposes.

The collaborative platform may also include an interactive environment that allows users to explore, create, and test different prompts for interacting with natural language processing models. This tool is designed to help users effectively utilize the capabilities of the collaborative platform by providing an intuitive interface for crafting and refining prompts.

The interactive environment of the collaborative platform offers several key benefits, including at least prompt experimentation, prompt refinement, collaboration and sharing, productivity and efficiency, reproducibility, and learning and education. With respect to prompt experimentation, users can experiment with diverse prompt structures, styles, and approaches to find the most effective way to elicit desired responses from different language models. This iterative process fosters better understanding of prompt engineering best practices. With respect to prompt refinement, with real-time feedback on our language models' outputs, users can iteratively refine prompts by tweaking wording, adding context, or adjusting tone until achieving the desired result. With respect to collaboration and sharing, the lab enables collaboration by allowing users to share successful prompts with others, accelerating the learning curve across teams and organizations. With respect to productivity and efficiency, a well-designed interface lets users quickly test and iterate prompts, saving time and effort compared to traditional natural language processing model interaction methods. With respect to reproducibility, version control and prompt history tracking allow revisiting prior prompts and outputs, valuable for debugging, auditing, and reproducibility. With respect to learning and education: the collaborative platform serves as an educational resource for exploring prompt engineering through real examples and interactive feedback loops.

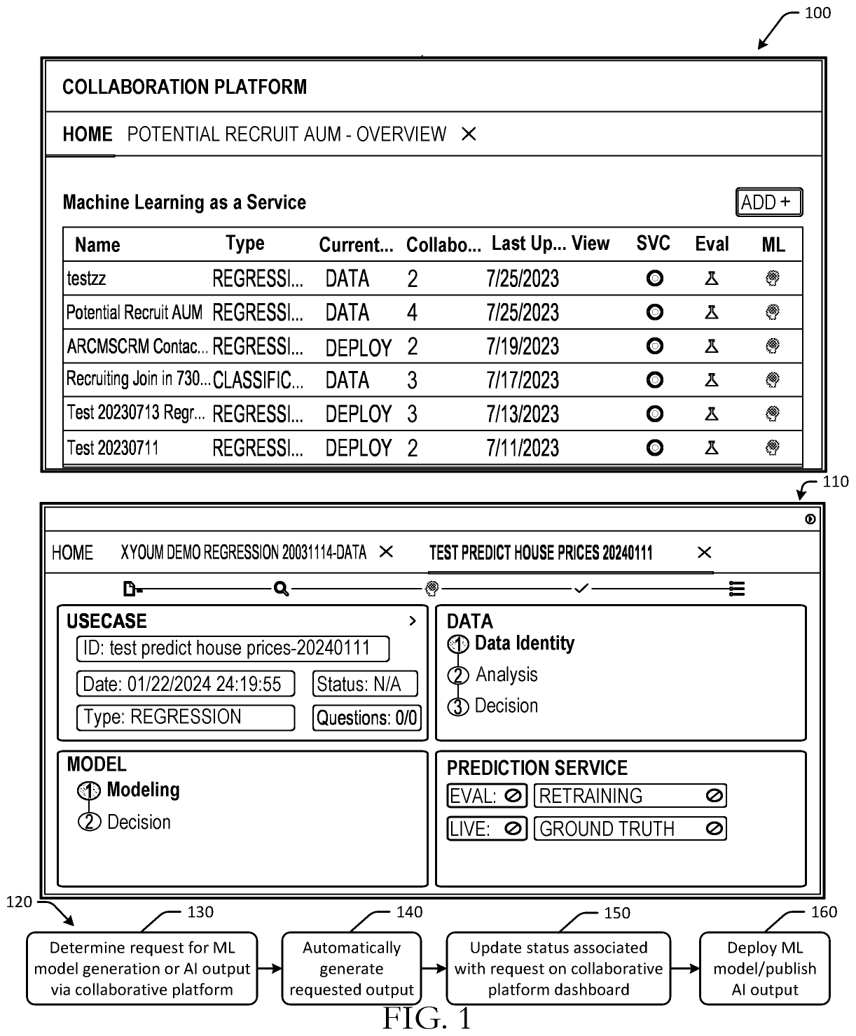

Turning to the figures, FIG. 1 shows an example use case for automated validation and deployment of machine learning models as a service in accordance with one or more example embodiments of the disclosure. In FIG. 1, two examples of user interfaces that may be presented via a collaborative platform are shown. A user may access these user interfaces of the collaborative platform via an application installed on a device, such as a desktop or laptop computer, tablet, smartphone, and/or any other type of device.

The first user interface 100 illustrates that the collaborative platform may simultaneously provide machine learning as a service for multiple different use cases involving different data and/or desired types of outputs (even for a single user). That is, the user interface 100 allows a user to add any number of different use cases to be serviced by the machine learning models as a service functionality of the collaborative platform. The user may view all of the different use cases via the user interface 100, as well as descriptive information about each of the use cases, such as types of tasks performed by the machine learning models trained for each of the use cases, a current status of the models associated with each of the use cases (for example, whether a model is undergoing evaluation or has been deployed, etc.), a number of users collaborating on the use cases, outputs produced by the machine learning models based on provided input data, and/or any other types of relevant information. The user may also select one of the individual use cases to view further information about that particular use cases (for example, via the second user interface 110). The user may also be able to edit certain parameters of the use cases. For example, the user may edit the type of output and/or the format of the output desired to be produced by the machine learning model for a given use case, as well as any other types of edits.

The user interface 110 shows a user interface that may be presented when a user selects one of the use cases in the listing of use cases shown in the user interface 100. The user interface 110 allows a user to view status information about distinct phases associated with the automated validation and deployment of machine learning models. The user may also be able to perform other types of operations via the user interface 110, such as providing new data, viewing outputs of the machine learning model associated with that use case, etc.

A first portion of the user interface 110 (shown at the top left hand corner of user interface 110) shows information associated with a first phase of the automated validation and deployment of machine learning models for a particular use case. Using the user interface 110, a user may input information about a use case for which it is desired that a machine learning model should be identified and trained to perform tasks associated with the user case. Non-limiting examples of input information that may be provided include type, available data, problem to be solved, expected solution, model scope, model maintenance requirements, and/or model performance requirements. Any other types of information may also be provided as well. The user interface 110 may include an option for a user to upload initial training data for the use case to the collaborative platform. Continuing the aforementioned use case relating to features of real-estate, the training data may include data relating to recent sales of real-estate, including data such as sales price, listed features of the properties, etc. In some instances, ground truth data may also be provided such that the models are trained in a supervised manner. The ground truth data may provide an indication of an expected output of the model based on the provided training data. For example, the ground truth data in the real-estate use case may include one or more features that were determined to have most heavily contributed to sales prices for the real-estate included in the training data. The data may also be automatically obtained by the collaborative platform in any other manner by accessing an external data store including the training data.

The type information may indicate a type of inference that the machine learning model is to perform in association with the particular use case. Examples of such inferences may include, but are not limited to, regression (e.g., predicting a continuous numeric value), binary classification (e.g., predicting true/false), multi-class classification (e.g., predicting categories), recommender (e.g., recommending a list of items based on an event), similarity (e.g., finding similar entities from a population to a given entity), forecasting (e.g., forecast a trend), etc. The available data information may indicate the historical data that is available for the use case (which may be used as training data for the model). The problem to be solved information may indicate the problem that the model may be used to solve (e.g., the task to be performed by the model). The expected solution information may indicate the expected response from the model. The model scope information may indicate known scope and/or limitations of either the data and/or the solution. The model maintenance requirements information may indicate how often the model should be re-trained. The model performance requirements information may indicate the expected performance of the model. Any other types of input information may also be provided.

In some instances, the system may analyze the provided information to determine if one or more conditions are met before identifying one or more machine learning models to evaluate for use in performing tasks associated with the use case. One condition may involve determining if the particular use case is valid for use with a machine learning model. For example, when a use case is submitted, the use case moves into a “new” phase where an operator or an automated system can make a decision about the use case being a valid machine learning use case based on one or more factors including the problem they trying to solve, whether the problem can be solved by machine learning, what the expected solution is, whether a machine learning solution feasible, whether sufficient data is available, and so forth. Another condition may involve determining if the provided expected solution is feasible. Any other conditions may also be verified as well. If one or more of these conditions (or other defined conditions) are not satisfied, then the collaborative platform may determine that a machine learning model should not be selected to perform tasks for the particular use case, and a notification of such may be provided to the user via the user interface 110.

A second portion of the user interface 110 (for example, shown in the top right hand corner of user interface 110) shows information associated with a second phase of the automated validation and deployment of machine learning models for a particular use case. Once the collaborative platform has verified that the use case is suitable for a machine learning model (in instances in which these conditions are required), any data associated with the use case may be provided for analysis. The collaborative platform may process the data and may return an interpretation of the data. For example, if the data is provided in a spreadsheet format (or even if the data is provided in another format), the collaborative platform may process the data and may generate a structured dataset including rows and columns of data representing the input data. This data may then be presented back to the user via the user interface such that the user may confirm that the system correctly processed the data (for example, to determine if the data is arranged correctly in rows and columns, if the names of the columns are correct, if the data entries are correct, etc.).

In certain embodiments, the data may also be automatically obtained. For example, the collaborative platform may obtain data from an external data store. In such embodiments, a user may provide an indication of a location of the external data store and may also provide access to the external data store. The collaborative platform may then automatically obtain any relevant data from the external data store without requiring the data to be manually uploaded by the user.

A feedback mechanism may also exist by which the user may indicate adjustments to the interpretation generation by the collaborative platform. For example, the user interface may allow the user to delete particular rows of data, add new data, and/or edit existing data. The user may also be able to indicate how certain data should be used by the collaborative platform. For example, the system can return its interpretation of uploaded data also present how the different columns will be used. Users can change the columns, including both the interpretation and can configure how the data should be used including deselecting columns.

The collaborative platform may also analyze the data and determine particular features of the data that are deemed to be more important than other features of the data. The system cleans the data, transforms all columns to numeric data and then based on the type of Model, the system does recursive feature reduction with cross validation using an appropriate algorithm. The system does this to determine important features for the column to be predicted.

A third portion of the user interface 110 (for example, shown in the bottom left hand corner of user interface 110) shows information associated with a third phase of the automated validation and deployment of machine learning models for a particular use case. In the third phase, the collaborative platform identifies a number of different types of machine learning models that may be applicable to the use case based on the input information provided in the first phase and the data analysis of the second phase. That is, rather than testing every different type of machine learning model for use with the use case, only a subset of all potential types of models may be selected for testing to reduce the latency of the process.

The particular types of machine learning models that are selected to be tested for use with the use case may be determined in any number of different ways. As one example, a user may indicate a type of task that is desired to be performed for the use case and the collaborative platform may select only those models that are best suited to perform the task. To better assist the user in defining the type of task, a listing of different types of tasks may be provided via the user interface for selection by the user (for example, a dropdown list may be provided, and the user may select a task from the dropdown list). As another example, the collaborative platform may automatically determine the type of task that is to be performed based on input information received from the user, such as types of input data, the desired output, etc. These are merely examples, and the subset of models initially selected for testing before a particular model is deployed in a live environment may also be determined in any other way.

Once the candidate machine learning models are identified, the collaborative platform provides any obtained input data to the various models to determine the model that is best suited to perform the tasks associated with the use case identified in the first phase. That is, the data is fed to the models and certain metrics about the performance of the models are determined based on the outputs produced by the models. Every request response is stored by the prediction router. Users also have the ability to upload ground truth data. This data should have an identifier column that the system uses to associate with responses (predictions). This is to be used to show accuracy metrics and to also calculate model drift.

A fourth portion of the user interface 110 (for example, shown in the bottom right hand corner of user interface 110) shows information associated with a fourth phase of the automated validation and deployment of machine learning models for a particular use case. The fourth phase may involve automatically selecting one of the machine learning models as the model that is to be used to perform the tasks associated with the use case. This determination may be made by the collaborative platform based on the results of the metrics produced during the third phase. That is, the collaborative platform may analyze the metrics associated with each of the candidate machine learning models and may select a single machine learning model that is associated with the most favorable metrics to transition into the next phase.

The machine learning model that is selected may, even after being identified as the best candidate out of the multiple machine learning models tested, still be subject to an evaluation period before being deployed in a live environment to be used in real-time to perform tasks for the use case. During the evaluation period, further test data may be uploaded to the collaborative platform (or automatically obtained) to be processed by the selected machine learning model. The machine learning model may process the data and produce an output based on the data. Additionally, ground truth data may be provided to the collaborative platform as well. The output of the machine learning model may be compared to the ground truth data to evaluate the performance of the model. The evaluation period may involve single evaluations, batch evaluations, single asynchronous evaluations, and/or batch asynchronous evaluations.

If the performance of the model does not satisfy a threshold level of performance, then the collaborative platform may automatically re-train the model based on the provided data and ground truth data (and/or may obtain further data for training). This process may be iterated until the machine learning model satisfies the threshold level of performance (the performance of the model converges to the threshold level of performance). As one non-limiting example, a numerical value representing the performance of the model may be determined (which may be a “confidence value”) and this numerical value may be compared to the threshold. The numerical value satisfies the threshold when the numerical value is equal to or greater than or equal to the threshold, for example.

To automatically deploy decoy production networks, an example process flow 120 is presented and may be performed, for example, by a device (as a non-limiting example, one or more servers). The device may include at least one memory that stores computer-executable instructions and at least one processor configured to access the at least one memory and execute the computer-executable instructions to perform various actions or operations, such as one or more of the operations in the process flow 120 of FIG. 1.

At block 130, the system (in some instances, reference to the “system” herein may also refer to the collaborative platform) determines a request for machine learning model generation. A user may desire to use the machine learning model as a service functionality of the collaborative platform to perform tasks associated with a use case. For example, the user may desire to use the machine learning model as a service functionality to analyze real estate data to identify features of properties that most heavily impacted sale prices of those properties. The user may access the collaborative platform and provide an indication of the use case as well as other types of input information that may then be used by the collaborative platform to generate a machine learning model for use to perform the tasks associated with the use case.

At block 140, the system automatically generates the requested output. Once the information about the desired use case and other input information is received, the collaborative platform may identify a subset of all potential types of machine learning models best suited to perform tasks associated with the use case for testing as described above. These selected machine learning models may be trained using the data and the machine learning models may be tested based on corresponding outputs using metrics as described above. The best performing machine learning model may be selected for the further evaluation phase.

At block 150, the system updates a status associated with the request on a dashboard of the collaborative platform. For example, as shown in the user interface 110, the user may be able to view status information as the collaborative platform progresses through the various phases of the process before a machine learning model is deployed in the live environment for use to perform tasks in association with the use case.

At block 160, the system deploys the machine learning model and publishes the output. Once the collaborative platform determines that the machine learning model satisfies the threshold level of performance, the machine learning model may be deployed in a live environment and may then be used to perform tasks associated with the use case indicated by the user. The machine learning model may then be provided with data for analysis and may produce outputs that may be published to the collaborative platform for viewing by the user via a user interface.

Example embodiments of the disclosure provide a number of technical features or technical effects. For example, in accordance with example embodiments of the disclosure, certain embodiments of the disclosure may automatically generate and deploy decoy production networks, which may be dynamically updated over time to give the appearance of the actual production network. Embodiments of the disclosure may provide security regardless of whether an unauthorized user has accessed an actual production network. As a result of improved functionality, network security may be improved, thereby improving functionality of computer systems. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Process and Use Cases

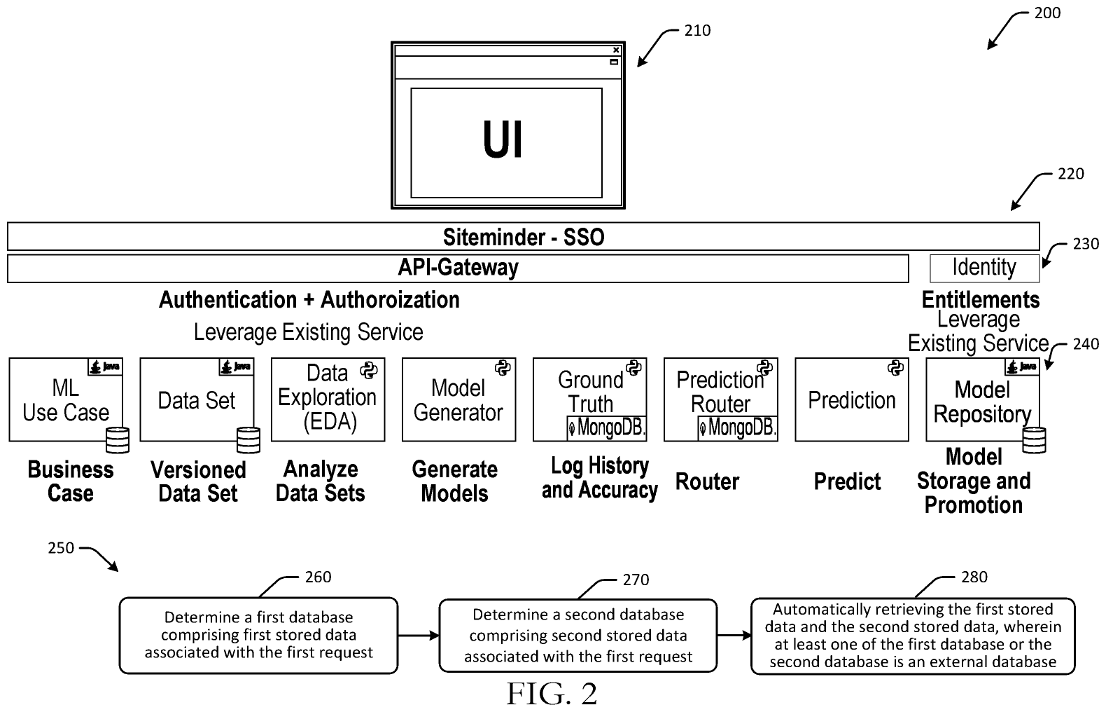

FIG. 2 is a schematic illustration of an example system architecture 200 in accordance with one or more example embodiments of the disclosure. While example embodiments of the disclosure may be described in the context of production network environments, it should be appreciated that the disclosure is more broadly applicable to any type of network environment.

The system architecture 200 may include an application that that presents a user interface that allows a user to perform any functionality associated with the collaborative platform as described herein. An authentication service may also be employed to provide secure access to the application. Additionally, an API may be leveraged that allows the application to access various backend services and/or data stores, as shown in FIG. 2. For example, the data stores may include a use case repository (the term “repository” may refer to a data store), a data set repository, a ground truth repository, and/or a model storage repository. This information may also be maintained in a single data store or any other number of data stores.

The use case repository may store information about use cases submitted by users for which tasks may be performed using machine learning models provided as a part of the machine learning model as a service functionality of the collaborative platform. This may include any information associated with the use case, such as a location of an external data store in which data associated with the use case is stored, a desired type output of a machine learning model using the data, a frequency at which data should be analyzed by the machine learning model, etc. For example, as shown in the user interface 100 of FIG. 1, one user may use the collaborative platform for different types of use cases potentially involving different types of data and/or different types of desired outputs. Additionally, multiple users may also access the collaborative platform simultaneously. Accordingly, the collaborative platform may be used to perform a number of tasks for a number of different users.

The data set repository may store any data that is manually uploaded by a user or automatically obtained by the collaborative platform. For example, any data that is used for training any of the machine learning models, any data that is obtained in a live environment to be processed by a selected machine learning model, etc. In some instances, the data repository may also include pointers to other external data stores from which data relating to a use case may automatically be obtained. Likewise, the ground truth repository may include any ground truth data that is used to train and/or evaluate a model (for example, in the fourth phase described with respect to FIG. 1). This ground truth data may be manually uploaded to the collaborative platform and/or automatically obtained by the collaborative platform.

The backend services may include, for example, a data exploration service (e.g., data understand functions, data analysis functions such as validation of data settings, cleaning data, transforming data, finding features, etc.), a model generator service, a prediction routing service, and/or a prediction service. The model generator service may perform any of the processes associated with receiving input data associated with a new use case indicated by a user, testing different types of machine learning models suited to perform tasks associated with the use case, selecting a best-performing machine learning model for evaluation and deployment in a live environment, etc.

The prediction router service may include (or have access to) a data store including associations between various use cases of different users and the specific models that were previously selected and trained to perform tasks for the various use cases. Given that the collaborative platform may store trained models for many different users using the machine learning as a service of the collaborative platform, the prediction routing service provides a mechanism by which it may be determined which of the trained machine learning models (which may be stored in the model repository) should be used to perform a task associated with a given use case. This prevents the collaborative platform from using the incorrect machine learning model for a given task. Therefore, when a request is received to perform a task (or when a task is automatically performed by the collaborative platform), the prediction router service may be leveraged to determine which model should be used to perform the task. The model may then be accessed and any relevant data may be provided to the model. The model may then produce an output using the data and the resulting output may be presented to a user via a user interface of the collaborative platform.

The prediction service performs any operations associated with use of a machine learning model in a live environment. For example, facilitating providing any new data to the machine learning model to perform tasks associated with the data and generate outputs based on the data, receive the outputs of the machine learning model and cause presentation of the outputs via the user interface, re-training any machine learning models, and/or any other relevant operation.

Example process flow 250 is presented and may be performed, for example, by a device (as a non-limiting example, one or more servers). The device may include at least one memory that stores computer-executable instructions and at least one processor configured to access the at least one memory and execute the computer-executable instructions to perform various actions or operations, such as one or more of the operations in the process flow 250 of FIG. 1.

At block 260, the system determines a first database comprising first stored data associated with a first request. At block 270, the system determines a second database comprising second stored data associated with the first request. For example, the first request may be a request for the collaborative platform to generate a machine learning model that may be used to perform a task or tasks associated with a desired use case. In some instances, the first request may be for at least one of: a numerical prediction, a binary output, a category prediction, a trend forecast, or a probability value (however, any other type of request may be provided as well). At block 280, the system automatically retrieves the first stored data and the second stored data, wherein at least one of the first database or the second database is an external database. That is, the collaborative platform may automatically retrieve initial training data that may be used to train one or more machine learning models for evaluation before a model is selected to be used in a live environment to perform the task or tasks associated with the use case.

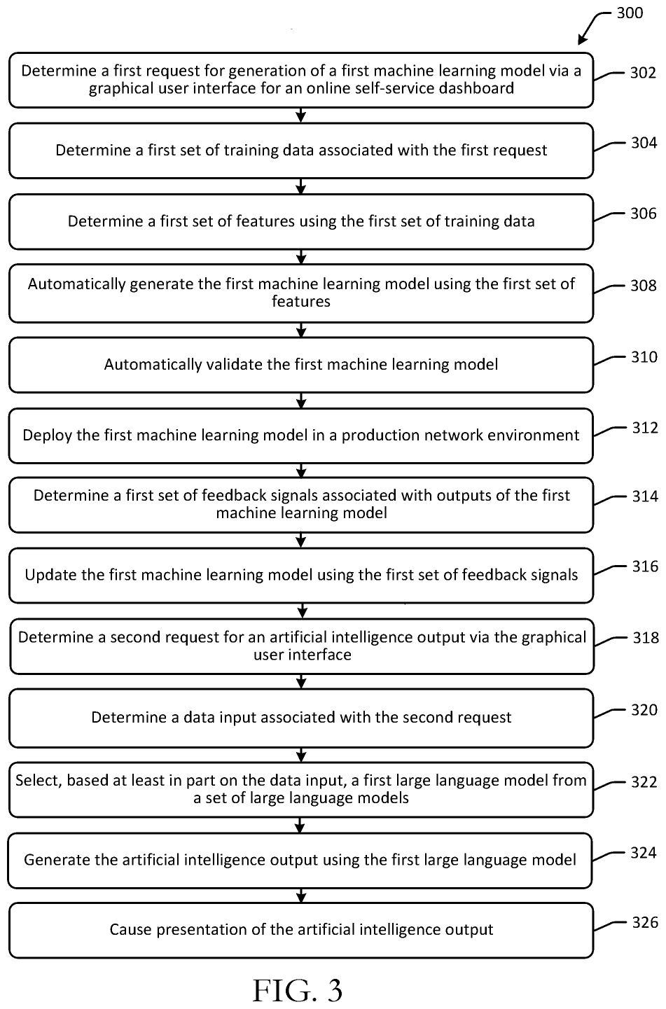

FIG. 3 depicts an example process flow 300 for automated validation and deployment of machine learning models as a service in accordance with one or more example embodiments of the disclosure. While example embodiments of the disclosure may be described in the context of production networks, it should be appreciated that the disclosure is more broadly applicable to any type of network. Some or all of the blocks of the process flows in this disclosure may be performed in a distributed manner across any number of devices. Some of the operations of the process flow 300 may be optional and may be performed in a different order.

At block 302 of the process flow 300, computer-executable instructions stored on a memory of a device, such as a server, may be executed to determine a first request for generation of a first machine learning model via a graphical user interface for an online self-service dashboard (for example, a user interface presented via a collaborative platform as described herein). The request may be made by a user indicating via the collaborative platform that they desire to use the machine learning model as a service functionality of the collaborative platform to perform tasks associated with a use case defined by the user. The user may also provide other input information relating to the use case, such as the type of output that is desired to be produced by the machine learning model for the user. In embodiments, the first request may be for at least one of: a numerical prediction, a binary output, a category prediction, a trend forecast, or a probability value. The first request may also include a purpose input, a desired accuracy metric, and a retraining schedule. However, the first request may also be any other type of request.

At block 304 of the process flow 300, computer-executable instructions stored on a memory of a device, such as a server, may be executed to determine a first set of training data associated with the first request. For example, the data may be data associated with the use case. The data may be automatically obtained from an external data source (the terms “data store” and “data source” may be used interchangeably herein) or may be manually uploaded to the collaborative platform by the user.

At block 306 of the process flow 300, computer-executable instructions stored on a memory of a device, such as a server, may be executed to determine a first set of features using the first set of training data.

At block 308 of the process flow 300, computer-executable instructions stored on a memory of a device, such as a server, may be executed to automatically generate the first machine learning model using the first set of features. The collaborative platform may determine a subset of all existing types of machine learning models that are most suited to perform the tasks associated with the use case. These models may be trained using the provided data and metrics about the performance of the different models may be generated. Based on the metrics, one of the tested machine learning models with the best performance may be selected for further evaluation and fine-tuning (for example, re-training the model to optimize the performance of the model before being deployed in the live environment).

At block 310 of the process flow 300, computer-executable instructions stored on a memory of a device, such as a server, may be executed to automatically validate the first machine learning model. This validation process may involve evaluating the machine learning model to determine if the accuracy of the outputs currently produced by the model satisfies a threshold level of performance. If the threshold level of performance is not met, then an iterative process may be performed by which the model is fine-tuned with further training data until the model meets the threshold level of performance.

At block 312 of the process flow 300, computer-executable instructions stored on a memory of a device, such as a server, may be executed to deploy the first machine learning model in a production network environment. That is, once the collaborative platform determines that the model meets the threshold level of performance, then the model may be deployed in the production network environment for usage to perform tasks in association with the use case as new data is received by the collaborative platform.

At block 314 of the process flow 300, computer-executable instructions stored on a memory of a device, such as a server, may be executed to determine a first set of feedback signals associated with outputs of the first machine learning model.

At block 316 of the process flow 300, computer-executable instructions stored on a memory of a device, such as a server, may be executed to update the first machine learning model using the first set of feedback signals.

At block 318 of the process flow 300, computer-executable instructions stored on a memory of a device, such as a server, may be executed to determine a second request for an artificial intelligence output via the graphical user interface. In some instances, the second request may include a request for at least one of: training data generation, text drafting, data extraction, or source code rewriting. However, any other type of request may also be made.

At block 320 of the process flow 300, computer-executable instructions stored on a memory of a device, such as a server, may be executed to determine a data input associated with the second request.

At block 322 of the process flow 300, computer-executable instructions stored on a memory of a device, such as a server, may be executed to select, based at least in part on the data input, a first large language model from a set of large language models.

At block 324 of the process flow 300, computer-executable instructions stored on a memory of a device, such as a server, may be executed to generate the artificial intelligence output using the first large language model.

At block 326 of the process flow 300, computer-executable instructions stored on a memory of a device, such as a server, may be executed to cause presentation of the artificial intelligence output.

Blocks 318-326, for example, may refer to a knowledge management and question-answering service that allows users to create custom knowledge bases and interact with them using natural language processing models. Once a knowledge base is populated, the core functionality of searching and interacting with the knowledge can be accessed through either the UI or APIs. The search capability allows users to enter natural language queries, which are then mapped to the semantic vector space. The service retrieves the most relevant documents from the knowledge base based on vector similarity and respects the metadata-based filtering, ensuring that users only receive responses from the relevant documents.

The language model, augmented with the retrieved context, generates natural language responses, effectively allowing users to “chat” with their knowledge base through both the UI and APIs. This powerful combination of retrieval and generation enables users to ask follow-up questions, seek clarifications, or dive deeper into specific topics, all while being grounded in the factual information contained within their accessible subset of the knowledge base.

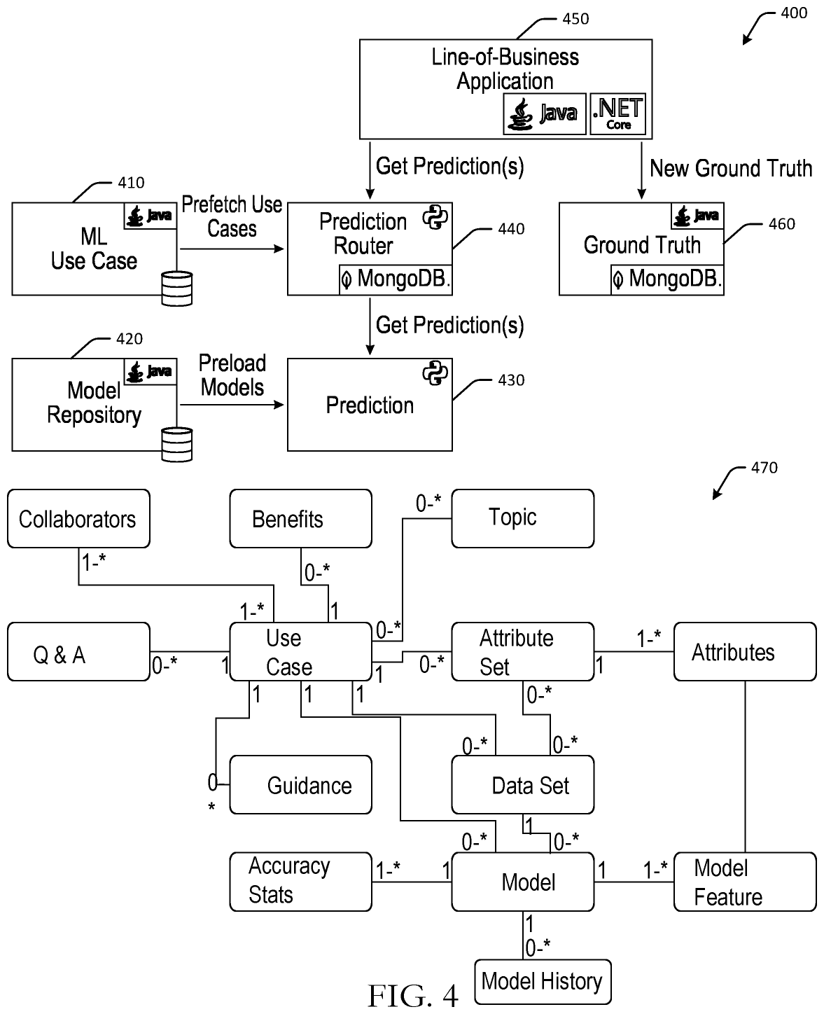

FIG. 4 depicts illustrations of a flow diagram 400 and a data architecture 470 for automated validation and deployment of machine learning models as a service in accordance with one or more example embodiments of the disclosure. While example embodiments of the disclosure may be described in the context of production network environments, it should be appreciated that the disclosure is more broadly applicable to any type of network environment. Some or all of the blocks of the process flows in this disclosure may be performed in a distributed manner across any number of devices. Some of the data flow or operations may be optional and may be performed in a different order.

The flow diagram 400 shows operations that may be performed involving a use case repository 410, a model repository 420, a prediction service 430, a prediction router service 440, a user-facing application 450, and a ground truth repository 460. These elements shown in the flow diagram 400 may be the same as similar elements shown in the system architecture of FIG. 2. The user-facing application 450 may allow a user to perform any number of different operations described herein, such as providing a new use case to the collaborative platform, uploading training data (also including ground truth data), uploading new data to receive an output from a trained model in the model repository 420, view outputs of the model, etc. That is, the user-facing application 450 may present any of the user interfaces described herein or otherwise to the user to allow the user to use the machine learning models as a service functionality of the collaborative platform.

The flow diagram 400 shows that a request for a task associated with a specific use case is provided to the prediction router service 440 via the user-facing application 450. Additional information about the particular use case may be stored in the use case repository 410. Based on the request, the prediction router service 440 determines the specific machine learning model that was previously trained and deployed to perform the specific task associated with the use case. An indication of this machine learning model may be provided to the prediction service 430, which may facilitate usage of the machine learning model, which may be stored in the model repository 420. The outputs produced by the machine learning model may then be provided back to the user-facing application 450 such that the results may then be viewed by the user via a user interface of the user-facing application 450.

The data architecture 470 illustrates examples of different types of data that may be used in association with the collaborative platform as described herein.

One or more operations of the methods, process flows, or use cases of FIGS. 1-4 may have been described above as being performed by a user device, or more specifically, by one or more program module(s), applications, or the like executing on a device. It should be appreciated, however, that any of the operations of the methods, process flows, or use cases of FIGS. 1-4 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-4 may be described in the context of the illustrative devices, it should be appreciated that such operations may be implemented in connection with numerous other device configurations.

The operations described and depicted in the illustrative methods, process flows, and use cases of FIGS. 1-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-4 may be performed.

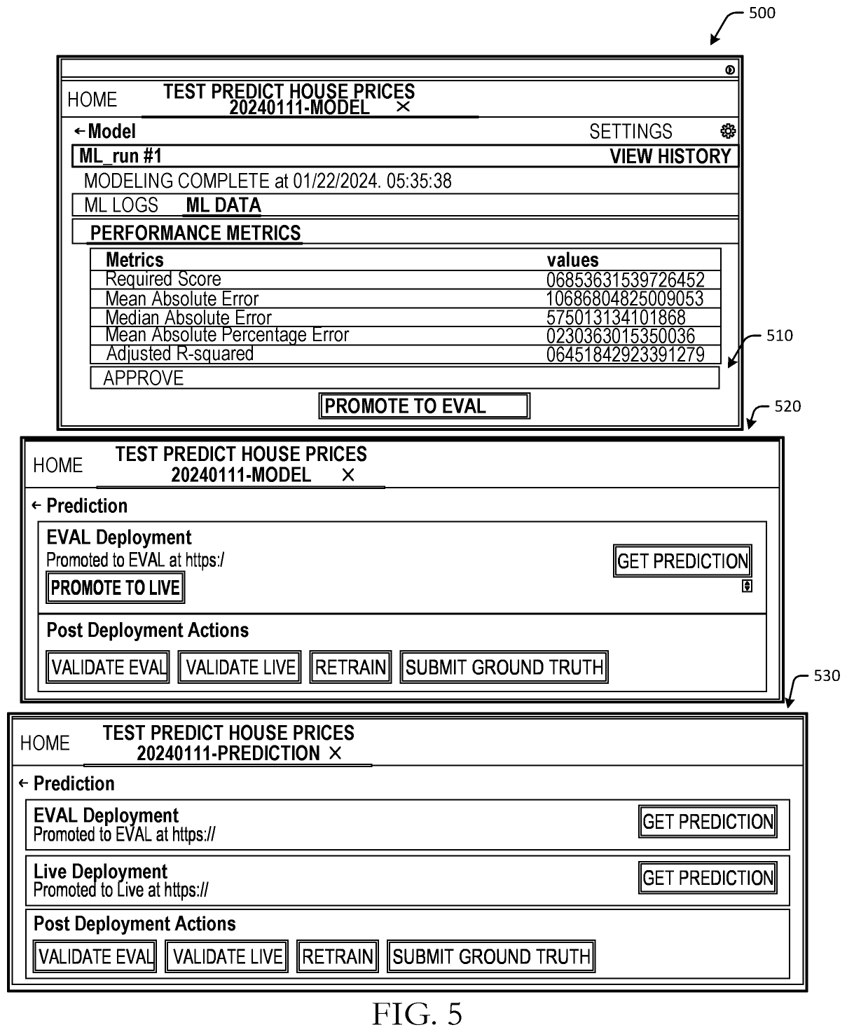

FIG. 5 depicts example user interfaces 500, 510, 520, and 530 for automated validation and deployment of machine learning models as a service in accordance with one or more example embodiments of the disclosure. Particularly, the use interfaces 500, 510, 520, 530 may be associated with the third and fourth phases of the process for automated validation and deployment of machine learning models as described with respect to FIG. 1.

The user interface 500 shows exemplary results of the process by which one or more machine learning models are tested for performing tasks associated with an indicated use case.

The use interface 510 shows an example of a user interface including a selectable button for selecting a particular machine learning model of the one or more tested machine learning models to an evaluation phase. As aforementioned, before a selected machine learning model is prompted to use in a “live” environment (for example, to perform tasks, such as generating outputs based on data received in association with a use case), the machine learning model may experience an intermediate evaluation process to ensure the machine learning model is properly trained to produce accurate outputs.

The user interface 520 shows an example of a user interface that may be presented when a particular machine learning model is selected for evaluation (for example, via the user interface 510) based on the results of the testing of the one or more machine learning models. A user may be able to submit ground truth data and further training data via the user interface 520. The user may also be able to initiate the evaluation of the machine learning model via the user interface 520. If the performance of the machine learning model during the evaluation phase is determined to be satisfactory, then the user may select a selectable element indicating that the machine learning model should be deployed for usage in a live environment.

The user interface 530 shows an example of a user interface that may be presented once the selected machine learning model has been transitioned into usage in a live environment. Once the machine learning model has been transitioned into usage in the live environment, a user may provide data to the collaborative platform and the collaborative platform may provide the data to the machine learning model to produce outputs using the data. The data may also be automatically obtained by the collaborative platform (for example, from an external data store indicated by the user).

Any of the steps of the third and/or fourth phases that are shown as being manually initiated by a user via the user interfaces 500, 510, 520, and 530 may also be performed automatically by the system. As one example, the process of selecting the machine learning model and transitioning the machine learning model to the evaluation phase may also be performed automatically by the system. In some instances, the entire process of testing the various models, selecting a particular model for evaluation, and promoting the model for use in the live environment may be an entirely automated process without requiring any user input. In such cases, the data associated with the various steps of this process may still be presented to the user via the collaborative platform. However, in other instances, this information may not necessarily be visible to the user. In such instances, the user may simply be provided an indication that the model has been selected and may be used to perform tasks for the user. The user may then provide data for the selected model to process to produce outputs (or an indication of a data storage location from which the data may be accessed may be provided to the collaborative platform).

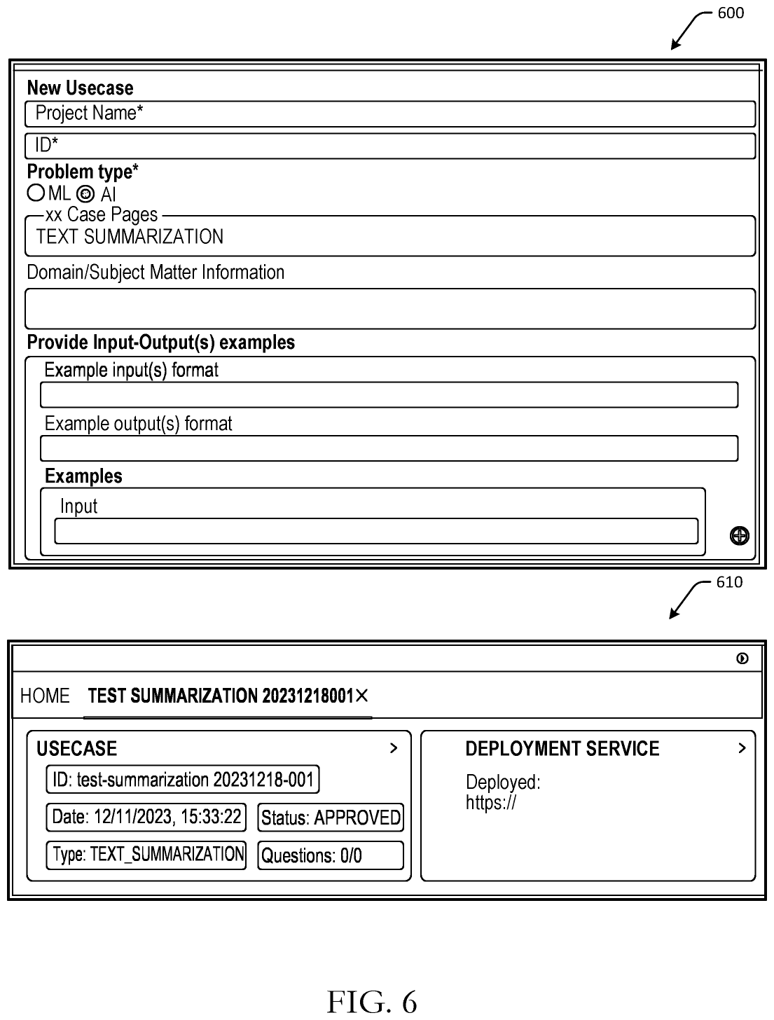

FIG. 6 depicts further example user interfaces 600 and 610 for automated validation and deployment of machine learning models as a service in accordance with one or more example embodiments of the disclosure. Particularly, the user interface 600 provides an example of a form associated with the creation of a new use case by a user via the collaborative platform. The form may allow the user to provide information about the use case such that the collaborative platform may then determine a machine learning model suitable for the use case. User interface 610 provides additional information about a particular use case, such as a type of task associated with the use case, a status of the use case, etc. A user may also be able to select a selectable element indicating that the user desired for an artificial intelligence output to be produced or for a specific type of artificial intelligence output to be produced, such as a machine learning model output.

The user interfaces depicts in FIGS. 5-6 are merely illustrative of some exemplary user interfaces associated with the collaborative platform for automated validation and deployment of machine learning models as described herein, and are not intended to illustrate all of the user interfaces that may be presented to the user via the collaborative platform. Other user interfaces may also be presented to allow a user to perform any other operations, view any information, etc. Additionally, the user interfaces illustrated in the figures herein may also be presented in any other manner, including any other arrangement of illustrated elements, including elements not shown in the figures.

### Illustrative Device Architecture

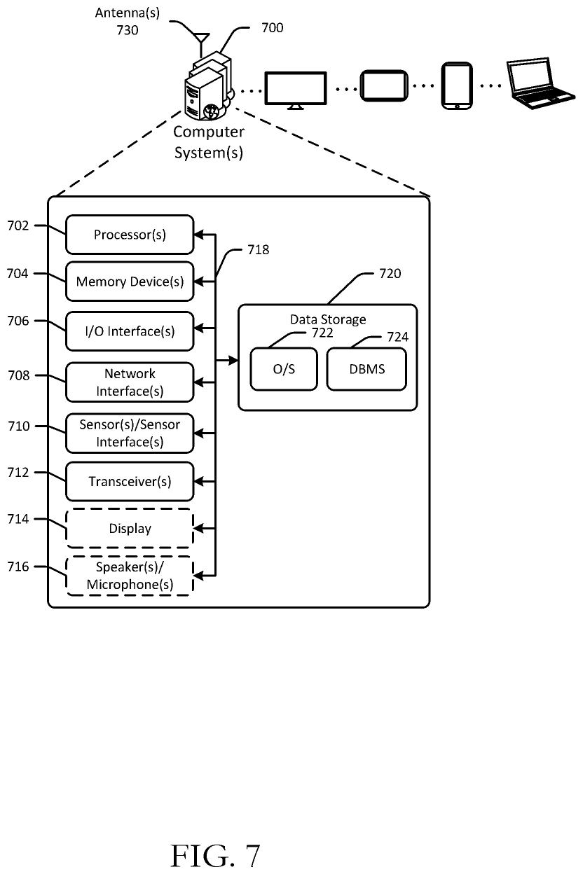

FIG. 7 is a schematic block diagram of one or more illustrative computer system(s) 700 in accordance with one or more example embodiments of the disclosure. The computer system(s) 700 may include any suitable computing device including, but not limited to, a server system, a voice interaction device, a mobile device such as a smartphone, a tablet, an e-reader, a wearable device, or the like; a desktop computer; a laptop computer; a content streaming device; or the like. The computer system(s) 700 may correspond to an illustrative device configuration for a computer system used in conjunction with any one of the system(s) of FIGS. 1-6.

The computer system(s) 700 may be configured to communicate with one or more servers, user devices, or the like. The computer system(s) 700 may be configured to cause the controller and/or computer system(s) to execute, and so forth.

The computer system(s) 700 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computer system(s) 700 may include one or more processors (processor(s)) 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more optional display(s) 714, one or more optional microphone(s) 716, and data storage 720. The computer system(s) 700 may further include one or more bus(es) 718 that functionally couple various components of the computer system(s) 700. The computer system(s) 700 may further include one or more antenna(s) 730 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit the exchange of information (e.g., data (including computer-executable code), signaling, etc.) between various components of the computer system(s) 700. The bus(es) 718 may include, without limitation, a memory bus or a memory controller, a peripheral bus, an accelerated graphics port, and so forth. The bus(es) 718 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 704 of the computer system(s) 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 704 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 704 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 720 may include removable storage and/or non-removable storage including, but not limited to, magnetic storage, optical disk storage, and/or tape storage. The data storage 720 may provide non-volatile storage of computer-executable instructions and other data. The memory 704 and the data storage 720, removable and/or non-removable, are examples of computer-readable storage media (CRSM) as that term is used herein.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. Moreover, output data generated as a result of execution of the computer-executable instructions by the processor(s) 702 may be stored initially in the memory 704, and may ultimately be copied to the data storage 720 for non-volatile storage.

More specifically, the data storage 720 may store one or more operating systems (O/S) 722; one or more database management systems (DBMS) 724; and one or more program module(s), applications, engines, computer-executable code, scripts, or the like. Some or all of these module(s) may be sub-module(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The data storage 720 may further store various types of data utilized by the components of the computer system(s) 700. Any data stored in the data storage 720 may be loaded into the memory 704 for use by the processor(s) 702 in executing computer-executable code. In addition, any data depicted as being stored in the data storage 720 may potentially be stored in one or more datastore(s) and may be accessed via the DBMS 724 and loaded in the memory 704 for use by the processor(s) 702 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 702 may be configured to access the memory 704 and execute the computer-executable instructions loaded therein. For example, the processor(s) 702 may be configured to execute the computer-executable instructions of the various program module(s), applications, engines, or the like of the computer system(s) 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 702 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 702 may be capable of supporting any of a variety of instruction sets.

Referring now to other illustrative components depicted as being stored in the data storage 720, the O/S 722 may be loaded from the data storage 720 into the memory 704 and may provide an interface between other application software executing on the computer system(s) 700 and the hardware resources of the computer system(s) 700. More specifically, the O/S 722 may include a set of computer-executable instructions for managing the hardware resources of the computer system(s) 700 and for providing common services to other application programs (e.g., managing memory allocation among various application programs). In certain example embodiments, the O/S 722 may control execution of the other program module(s). The O/S 722 may include any operating system now known or which may be developed in the future including, but not limited to, any server operating system, any mainframe operating system, or any other proprietary or non-proprietary operating system.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages. The DBMS 724 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computer system(s) 700 is a mobile device, the DBMS 724 may be any suitable lightweight DBMS optimized for performance on a mobile device.

Referring now to other illustrative components of the computer system(s) 700, the input/output (I/O) interface(s) 706 may facilitate the receipt of input information by the computer system(s) 700 from one or more I/O devices as well as the output of information from the computer system(s) 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computer system(s) 700 or may be separate. The I/O devices may further include, for example, any number of peripheral devices such as data storage devices, printing devices, and so forth.

The I/O interface(s) 706 may also include an interface for an external peripheral device connection such as universal serial bus (USB), FireWire, Thunderbolt, Ethernet port or other connection protocol that may connect to one or more networks. The I/O interface(s) 706 may also include a connection to one or more of the antenna(s) 730 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The computer system(s) 700 may further include one or more network interface(s) 708 via which the computer system(s) 700 may communicate with any of a variety of other systems, platforms, networks, devices, and so forth. The network interface(s) 708 may enable communication, for example, with one or more wireless routers, one or more host servers, one or more web servers, and the like via one or more networks.

The antenna(s) 730 may include any suitable type of antenna depending, for example, on the communications protocols used to transmit or receive signals via the antenna(s) 730. Non-limiting examples of suitable antennas may include directional antennas, non-directional antennas, dipole antennas, folded dipole antennas, patch antennas, multiple-input multiple-output (MIMO) antennas, or the like. The antenna(s) 730 may be communicatively coupled to one or more transceivers 712 or radio components to which or from which signals may be transmitted or received.

As previously described, the antenna(s) 730 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 730 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 730 may be configured to transmit or receive radio frequency signals within any suitable frequency range forming part of the unlicensed portion of the radio spectrum.

The antenna(s) 730 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 712 may include any suitable radio component(s) for—in cooperation with the antenna(s) 730—transmitting or receiving radio frequency (RF) signals in the bandwidth and/or channels corresponding to the communications protocols utilized by the computer system(s) 700 to communicate with other devices. The transceiver(s) 712 may include hardware, software, and/or firmware for modulating, transmitting, or receiving—potentially in cooperation with any of antenna(s) 730—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 712 may further include hardware, firmware, or software for receiving GNSS signals. The transceiver(s) 712 may include any known receiver and baseband suitable for communicating via the communications protocols utilized by the computer system(s) 700. The transceiver(s) 712 may further include a low noise amplifier (LNA), additional signal amplifiers, an analog-to-digital (A/D) converter, one or more buffers, a digital baseband, or the like.

The sensor(s)/sensor interface(s) 710 may include or may be capable of interfacing with any suitable type of sensing device such as, for example, inertial sensors, force sensors, thermal sensors, photocells, and so forth. Example types of inertial sensors may include accelerometers (e.g., MEMS-based accelerometers), gyroscopes, and so forth.

The optional display(s) 714 may be configured to output light and/or render content. The optional speaker(s)/microphone(s) 716 may be any device configured to receive analog sound input or voice data.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computer system(s) 700, and/or hosted on other computing device(s) accessible via one or more networks, may be provided to support functionality provided by the program module(s), applications, or computer-executable code depicted in FIG. 7 and/or additional or alternate functionality. Further, functionality may be modularized differently such that processing described as being supported collectively by the collection of program module(s) depicted in FIG. 7 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 7 may be implemented, at least partially, in hardware and/or firmware across any number of devices.

It should further be appreciated that the computer system(s) 700 may include alternate and/or additional hardware, software, or firmware components beyond those described or depicted without departing from the scope of the disclosure. More particularly, it should be appreciated that software, firmware, or hardware components depicted as forming part of the computer system(s) 700 are merely illustrative and that some components may not be present or additional components may be provided in various embodiments. While various illustrative program module(s) have been depicted and described as software module(s) stored in the data storage 720, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

That which is claimed is:

1. A method comprising:
determining, by one or more computer processors coupled to memory, a first request for generation of a first machine learning model via a graphical user interface for an online self-service dashboard;
determining a first set of training data associated with the first request;
determining a first set of features using the first set of training data;
automatically generating the first machine learning model using the first set of features;
automatically validating the first machine learning model;
deploying the first machine learning model in a production network environment;
determining a first set of feedback signals associated with outputs of the first machine learning model;
updating the first machine learning model using the first set of feedback signals;
determining a second request for an artificial intelligence output via the graphical user interface;
determining a data input associated with the second request;
selecting, based at least in part on the data input, a first large language model from a set of large language models;
generating the artificial intelligence output using the first large language model; and
causing presentation of the artificial intelligence output.

2. The method of claim 1, wherein determining the first set of training data comprises:
determining a first database comprising first stored data associated with the first request;
determining a second database comprising second stored data associated with the first request; and
automatically retrieving the first stored data and the second stored data;
wherein at least one of the first database or the second database is an external database.

3. The method of claim 2, wherein the first stored data is unstructured data, the method further comprising:
automatically generating a structured dataset using the first stored data.

4. The method of claim 1, further comprising:
causing the graphical user interface to be updated with a first status of the first request and a second status of the second request.

5. The method of claim 1, further comprising:
determining weight values corresponding to individual features in the first set of features.

6. The method of claim 1, further comprising:
determining a confidence score associated with output of the first machine learning model at least a portion of the first set of training data;
wherein automatically validating the first machine learning model comprises automatically validating the first machine learning model based at least in part on the confidence score.

7. The method of claim 1, further comprising:
determining a third request for use of the first machine learning model; and
automatically approving the third request.

8. The method of claim 1, wherein the graphical user interface comprises selectable options of at least: generating a machine learning model and generating an artificial intelligence output.

9. The method of claim 1, wherein the first request is for at least one of: a numerical prediction, a binary output, a category prediction, a trend forecast, or a probability value.

10. The method of claim 1, wherein the second request is for at least one of: training data generation, text drafting, data extraction, or source code rewriting.

11. The method of claim 1, further comprising:
determining a second set of training data associated with the first request;
wherein automatically validating the first machine learning model comprises automatically validating the first machine learning model using the second set of training data.

12. The method of claim 1, wherein the first request comprises a purpose input, a desired accuracy metric, and a retraining schedule.

13. A system comprising:
memory that stores computer-executable instructions; and
at least one processor configured to access the memory and execute the computer-executable instructions to:
determine a first request for generation of a first machine learning model via a graphical user interface for an online self-service dashboard;
determine a first set of training data associated with the first request;
determine a first set of features using the first set of training data;
automatically generate the first machine learning model using the first set of features;
automatically validate the first machine learning model;
deploy the first machine learning model in a production network environment;
determine a first set of feedback signals associated with outputs of the first machine learning model;
update the first machine learning model using the first set of feedback signals;
determine a second request for an artificial intelligence output via the graphical user interface;
determine a data input associated with the second request;
select, based at least in part on the data input, a first large language model from a set of large language models;
generate the artificial intelligence output using the first large language model; and
cause presentation of the artificial intelligence output.

14. The system of claim 13, wherein the at least one processor is configured to determine the first set of training data by executing the computer-executable instructions to:
determine a first database comprising first stored data associated with the first request;
determine a second database comprising second stored data associated with the first request; and
automatically retrieve the first stored data and the second stored data;
wherein at least one of the first database or the second database is an external database.

15. The system of claim 14, wherein the first stored data is unstructured data, and wherein the at least one processor is further configured to access the memory and execute the computer-executable instructions to:
automatically generate a structured dataset using the first stored data.

16. The system of claim 13, wherein the at least one processor is further configured to access the memory and execute the computer-executable instructions to:
cause the graphical user interface to be updated with a first status of the first request and a second status of the second request.

17. The system of claim 13, wherein the at least one processor is further configured to access the memory and execute the computer-executable instructions to:
determine weight values corresponding to individual features in the first set of features.

18. The system of claim 13, wherein the at least one processor is further configured to access the memory and execute the computer-executable instructions to:
determine a third request for use of the first machine learning model; and
automatically approve the third request.

19. The system of claim 13, wherein the graphical user interface comprises selectable options of at least: generating a machine learning model and generating an artificial intelligence output;
wherein the first request is for at least one of: a numerical prediction, a binary output, a category prediction, a trend forecast, or a probability value; and
wherein the second request is for at least one of: training data generation, text drafting, data extraction, or source code rewriting.

20. A method comprising:
determining, by one or more computer processors coupled to memory, a first request for generation of a first machine learning model via a graphical user interface for an online self-service dashboard;
determining a first database comprising first stored data associated with the first request, wherein the first stored data is unstructured data;
determining a second database comprising second stored data associated with the first request;
automatically generating a structured dataset using the first stored data;
automatically retrieving the first stored data and the second stored data, wherein the first stored data and the second stored data are a first set of training data;
determining a first set of features using the first set of training data;
automatically generating the first machine learning model using the first set of features;
automatically validating the first machine learning model;
deploying the first machine learning model in a production network environment;
determining a first set of feedback signals associated with outputs of the first machine learning model updating the first machine learning model using the first set of feedback signals;
determining a second request for an artificial intelligence output via the graphical user interface;
determining a data input associated with the second request;
selecting, based at least in part on the data input, a first large language model from a set of large language models;
generating the artificial intelligence output using the first large language model; and
causing presentation of the artificial intelligence output.
